(19) United States
(12) Patent Application Publication
(10) Pub. No.: US 2020/0118777 A1
(43) Pub. Date: Apr. 16, 2020

(54) TEMPERATURE SWITCH AND INSULATING CASE FOR TEMPERATURE SWITCH

(71) Applicant: Uchiya Thermostat Co., Ltd., Saitama (JP)

(72) Inventor: Hideaki Takeda, Saitama (JP)

(21) Appl. No.: 16/070,977

(22) PCT Filed: Nov. 9, 2016
(86) PCT No.: PCT/JP2016/083299

§ 371 Date: Jul. 18, 2018

(30) Foreign Application Priority Data
Jan. 26, 2016 (JP) 2016-012398

(51) Int. Cl. H01H 37/04; H01H 37/52

(52) U.S. Cl. CPC H01H 37/04; H01H 37/52

(57) ABSTRACT

A temperature switch includes a temperature detection unit configured to detect a temperature so as to move a movable contact to a position that is in contact with a fixed contact and to a position that is separated from the fixed contact, a first lead wire that is connected to the fixed contact and that includes a covering member, a second lead wire that is connected to the movable contact and that includes a covering member, and a first-insulation-case member and a second-insulation-case member each of which includes a first-lead-wire concave portion and a second-lead-wire concave portion, and which are fit into each other so as to form accommodation space S that accommodates the temperature detection unit, the movable contact, and the fixed contact, where first-lead-wire concave portion accepts insertion of the covering member of the first lead wire and the second-lead-wire concave portion accepts insertion of the covering member of the second lead wire.

### FIELD

The present invention is related to a temperature switch that opens and closes an electric circuit and to a temperature-switch insulation case used for this type of temperature switch.

### BACKGROUND

Temperature switches have conventionally been known in which the insulation case is filled with a filling material such as a hardening resin so as to mechanically hold a lead wire that is connected to a terminal unit accommodated in the insulation case (see Patent Document 1 for example).

Temperature switches are also known in which the upper and lower insulation-case members are fit into each other although they just sandwich a plate-like terminal instead of holding a lead wire (see Patent Document 2 for example).

### PRIOR ART DOCUMENT

### Patent Document

[Patent Document 1] Japanese Laid-open Patent Publication No. 2001-35330
[Patent Document 2] Japanese Laid-open Patent Publication No. 2007-242351

### SUMMARY

### Technical Problem

Incidentally, the conventional filling-material filling process has two purposes. One is insulation, and the other is the reinforcement of the portion at which the lead wire and the terminal are connected. The insulation is set depending upon the physical distance between the internal live part and the external environment, and requires a dimension that will not cause a problem even when the boundary surface between the lead wire and the filling material peels. For the reinforcement, a hardening resin is advantageous in protecting the above internal connection portion from an external force because the internal connection portion uses a core wire (lead wire).

Also, the covering member of a lead wire is required to be able to respond to bending, and is made of a resin that is relatively flexible. Meanwhile, a filling material used for the above filling is made of a resin that is in a liquid state during the filling and hardens in response to a chemical reaction. This may lead to a problem on the boundary surface between the covering member of a lead wire, which is relatively soft, and a filling material that is relatively hard. For example, there is a problem in which strongly bending a lead wire makes an end portion of the filling material damage the covering member of the lead wire.

Also, the covering member of a lead wire and a filling material tend to fail to be adhered to each other with a high strength, often leading to a situation in which strongly bending the lead wire causes the covering member of the lead wire and the filling material to peel from each other on the boundary surface. This also leads to a problem in which the way of providing a lead wire has to be limited such as for example limiting the range within which the lead wire can bend in order to prevent the peeling.

Further, a filling material is in a liquid state during the filling, leading to problems in which the filling operations require expertise, the hardening of the filling material requires a thermal treatment, and stains are made by a spilt filling material. Note that a filling material being in a liquid state during the filling results in elevation of the center portion of an end portion because of the surface tension, damaging the covering member of the lead wire more often. Further, when the hardening of the filling material requires a heat treatment, the insulation case will also be limited for its heat resistance.

It is an object of the present invention to provide a temperature switch and a temperature-switch insulation case that can prevent damage to the covering member of a lead wire and can surely hold the lead wire, through a simple assembly operation.

### Solution to Problem

According to an aspect, a temperature switch includes a temperature detection unit configured to detect a temperature so as to move a movable contact to a position that is in contact with a fixed contact and to a position that is separated from the fixed contact, a first lead wire that is connected to the fixed contact and that includes a covering member, a second lead wire that is connected to the movable contact and that includes a covering member, and a first-insulation-case member and a second-insulation-case member each of which includes a first-lead-wire concave portion and a second-lead-wire concave portion, and which are fit into each other so as to form an accommodation space that accommodates the temperature detection unit, the movable contact, and the fixed contact, where the first-lead-wire concave portion accepts insertion of the covering member of the first lead wire and the second-lead-wire concave portion accepts insertion of the covering member of the second lead wire.

According to another aspect, a temperature-switch insulation case arranged in a temperature switch that includes a temperature detection unit configured to detect a temperature so as to move a movable contact to a position that is in contact with a fixed contact and to a position that is separated from the fixed contact includes a first-insulation-case member and a second-insulation-case member each of which includes a first-lead-wire concave portion and a second-lead-wire concave portion, and which are fit into each other so as to form an accommodation space that accommodates the temperature detection unit, the movable contact, and the fixed contact, where the first-lead-wire concave portion accepts insertion of a covering member of a first lead wire that is connected to the fixed contact and that includes the covering member and the second-lead-wire concave portion accepts insertion of a covering member of a second lead wire that is connected to the movable contact and that includes the covering member.

### Advantageous Effects of Invention

The present invention can prevent damage to the covering member of a lead wire and can surely hold the lead wire, through a simple assembly operation.

### BRIEF DESCRIPTION OF DRAWINGS

FIG. 1 is an exploded perspective view illustrating a temperature switch according to the first embodiment;

FIG. 2 is a perspective view illustrating the temperature switch according to the first embodiment;

FIG. 3 is an exploded perspective view illustrating a temperature-switch insulation case according to the first embodiment;

FIG. 4 is an exploded perspective view illustrating a temperature-switch insulation case according to the second embodiment;

FIG. 5 is an exploded perspective view illustrating a temperature-switch insulation case according to the third embodiment;

FIG. 6 is an exploded perspective view illustrating a temperature-switch insulation case according to the fourth embodiment;

FIG. 7 is an exploded perspective view illustrating a temperature-switch insulation case according to the fifth embodiment; and

FIG. 8 is an exploded perspective view illustrating a temperature-switch insulation case according to the sixth embodiment.

### DESCRIPTION OF EMBODIMENTS

Hereinafter, explanations will be given for the temperature switches and the temperature-switch insulation cases according to the first through sixth embodiments of the present invention by referring to the drawings.

### First Embodiment

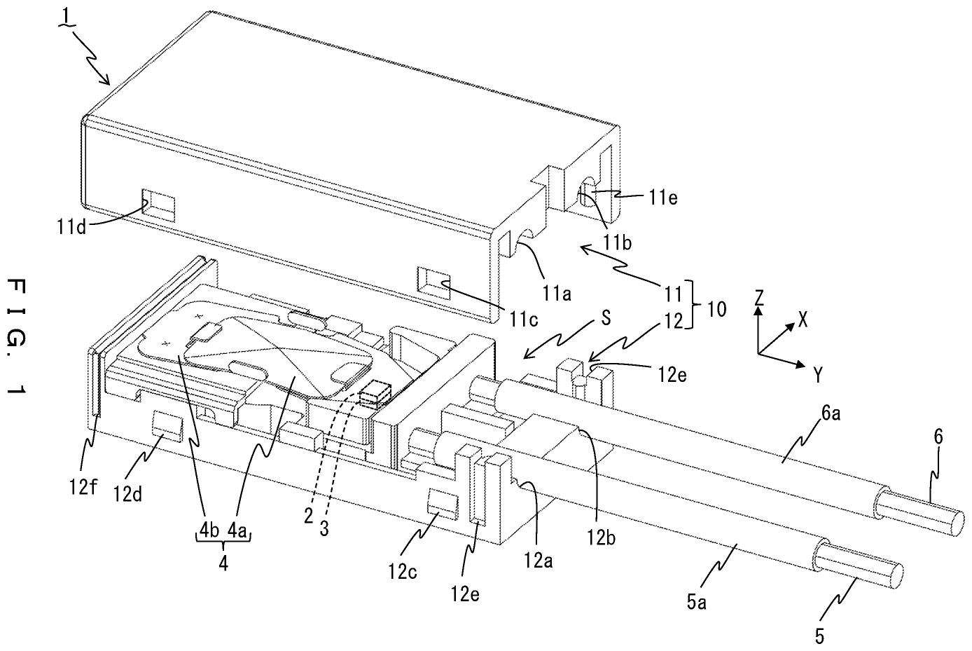

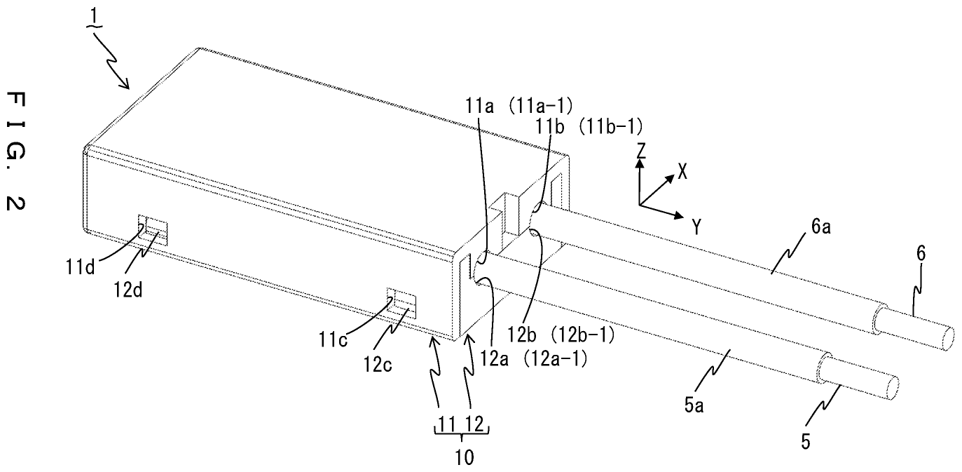

FIG. 1 is an exploded perspective view illustrating a temperature switch 1 according to the first embodiment. FIG. 2 is a perspective view illustrating the temperature switch 1 according to the first embodiment.

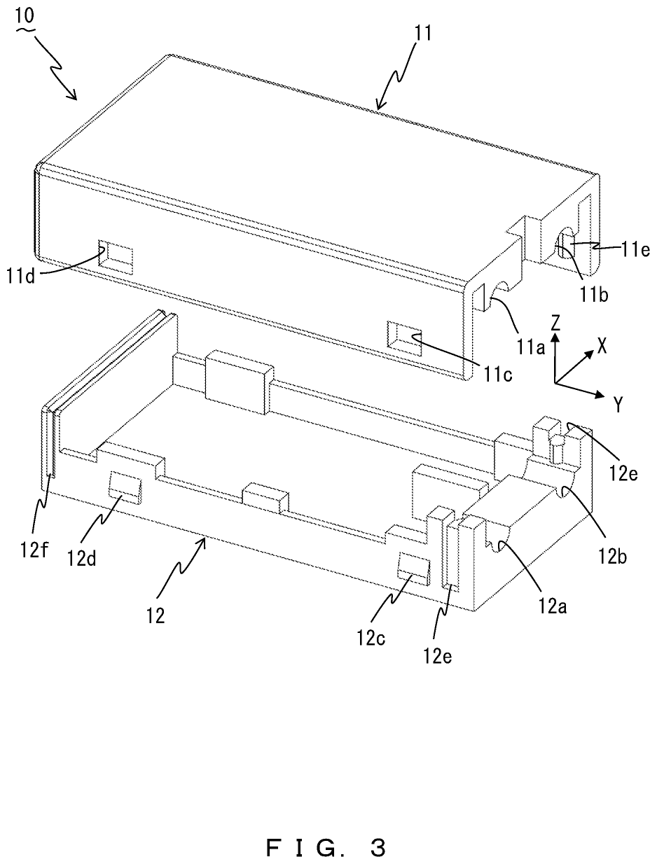

FIG. 3 is an exploded perspective view illustrating a temperature-switch insulation case (which will hereinafter be referred to simply as “insulation case”) 10 according to the first embodiment. The temperature switch 1 includes a movable contact 2, a fixed contact 3, a temperature detection unit 4, a first lead wire 5, a second lead wire 6, and the insulation case 10. The temperature switch 1 can be used for various purposes, and for example is embedded in an electric device such as an electric motor so as to operate to break the current path in response to overheating or overcurrent in the electric device.

The movable contact 2 is fixed to the bottom face of one end of a movable plate 4b, which will be described later, in the longitudinal directions (identical to for example the axial directions (Y directions) of the first and second lead wires 5 and 6, which will be described later), and moves, through an inverted operation of the movable plate 4b, to the position that is in contact with the fixed contact 3 (see FIG. 1) and to a position that is separated from the fixed contact 3. The movable contact 2 is electrically connected to the second lead wire 6 via a terminal (not illustrated). The fixed contact 3 is electrically connected to the first lead wire 5 as well via a terminal (not illustrated). Note the above portion at which the terminal and the first and second lead wires 5 and 6 are connected is for example a position different from the temperature detection unit 4. Also, the movable contact 2 and the fixed contact 3 are depicted by the hidden lines (dashed lines) in FIG. 1 because they are behind the movable plate 4b. While FIG. 1 illustrates a case in which the first and second lead wires 5 and 6 are collaterally inserted through the same plane of the insulation case 10, a different configuration is also possible including a configuration for example in which the first lead wire 5 is inserted through one of the two opposed faces of the insulation case 10 and the second lead wire 6 is inserted through the other face.

The temperature detection unit 4 includes a bimetal 4a and the movable plate 4b to detect a temperature, and thereby move the movable contact 2 to the position that is in contact with the fixed contact 3 and to a position that is separated from the fixed contact 3.

The bimetal 4a is a thermally actuated element that inverts the bending-back direction by treating the set temperature as a boundary. The movable plate 4b supports the bimetal 4a while being in surface contact with the bimetal 4a, and is elastically deformed by the inversion of the bimetal 4a and in accordance with the shape of the bimetal 4a. Note that it is desirable that the movable plate 4b be a good conductor of electricity in order to form a current path between the movable contact 2 and the second lead wire 6.

In a normal state, the bimetal 4a and the movable plate 4b have their center portions, which are in the longitudinal directions (Y directions that are identical to the axial directions of the first and second lead wires 5 and 6) as illustrated in FIG. 1, inverted upward to form convex portions, and both sides of the convex portions face downward. In this normal state, the movable contact 2 and the fixed contact 3 are in contact with each other. In other words, the electric contact of the energizing circuit of the electric device is closed so that a current flows through the above current path.

When the ambient temperature exceeds the set temperature, the center portions in the longitudinal directions of the bimetal 4a and the movable plate 4b are inverted to form downward-facing convex portions, and both sides of the convex portions face upward. This moves the movable contact 2 to a position that is separated from the fixed contact 3. In other words, the electric contact of the energizing circuit of the electric device is opened to break the current path.

Note that the temperature detection unit 4 is not limited to a configuration having the bimetal 4a and the movable plate 4b, and may employ a different configuration such as for example a configuration of moving a movable contact by the inflation of a gas or a liquid. The first and second lead wires 5 and 6 are flexible, and are at least partially covered by covering members 5a and 6a. The covering members 5a and 6a are elastic bodies such as for example silicone rubber, fluorocarbon rubber, or a plastic resin.

The insulation case 10 has the shape of a rectangular parallelepiped having edges that are parallel to the X, Y, or Z direction each of which is orthogonal to the others, and includes a first-insulation-case member 11 and a second-insulation-case member 12 fit into each other to form accommodation space S illustrated in FIG. 1 accommodating the movable contact 2, the fixed contact 3, the temperature detection unit 4, etc. The insulation case 10 uses for example an insulative synthetic resin for its material. In an example, the first-insulation-case member 11, which is above the second-insulation-case member 12, is arranged to cover the second-insulation-case member 12 on the faces on the far side (left side in FIG. 1 and FIG. 3) and the left and right sides (front side and the back side in FIG. 1 and FIG. 3) seen from the near side, i.e. the faces other than the face on the near side (right side in FIG. 1 and FIG. 3), which is the exit side on which the first and second lead wires 5 and 6 exit from the temperature switch 1.

The first-insulation-case member 11 includes a first-lead-wire concave portion 11a and a second-lead-wire concave portion 11b, and the second-insulation-case member 12 includes a first-lead-wire concave portion 12a and a second-lead-wire concave portion 12b. The first-insulation-case member 11 further includes two pairs of external-lock openings 11c and 11d, a pair of near-side convex portions 11e, and one far-side convex portion (not illustrated). The second-insulation-case member 12 further includes two pairs of external-lock clicks 12c and 12d, a pair of near-side grooves 12e and 12e, and one far-side groove 12f.

The first-lead-wire concave portions 11a and 12a and the second-lead-wire concave portions 11b and 12b are parallel to the axial directions of the first and second lead wires 5 and 6 (Y directions), and have a semicylindrical shape having radiuses roughly identical to (or, desirably, somewhat greater than) those of the first and second lead wires 5 and 6. It is desirable that the first-lead-wire concave portions 11a and 12a and the second-lead-wire concave portions 11b and 12b in the axial directions (Y directions) be long enough to ensure the insulation distance in the insulation case 0.

The first-lead-wire concave portion 11a, which is for the first-insulation-case member 11, and the first-lead-wire concave portion 12a, which is for the second-insulation-case member 12, are opposed to each other in for example the Z directions, which are vertical directions, and the covering member 5a of the first lead wire 5 is inserted between them. The second-lead-wire concave portion 11b, which is for the first-insulation-case member 11, and the second-lead-wire concave portion 12b, which is for the second-insulation-case member 12, are also opposed to each other in for example the Z directions, which are vertical directions, and the covering member 6a of the second lead wire 6 is inserted between them.

For the end portions on the near side in the Y directions (right side in FIG. 2), which is the exit side on which the first and second lead wires 5 and 6 exit from the temperature switch 1, it is desirable as illustrated in FIG. 2 for the first-lead-wire concave portions 11a and 12a and the second-lead-wire concave portions 11b and 12b to employ a configuration in which the end portions do not damage the covering members 5a and 6a of the first and second lead wires 5 and 6 even when the first and second lead wires 5 and 6 bend, such by for example forming chamfered portions 11a-1, 12a-1, 11b-1, and 12b-1 all along the circumference of the end portions.

As illustrated in FIG. 1 and FIG. 3, the two pairs of the external-lock openings 11c and 11d of the first-insulation-case member 11 pierce the first-insulation-case member 11 in the arrangement directions of the first and second lead wires 5 and 6 (X directions), which are the directions orthogonal to the axial directions (Y directions), and are arranged at opposed positions in this arrangement directions (X directions) (in FIG. 1 and FIG. 3, only the front side is illustrated and the back side is blocked). The two pairs of the external-lock clicks 12c and 12d of the second-insulation-case member 12 project to the outside in the arrangement directions of the first and second lead wires 5 and 6 (X directions) (the side opposite from accommodation space S illustrated in FIG. 1), and are arranged at opposed positions in the arrangement directions (X directions) (in FIG. 1 and FIG. 3, only the front side is illustrated and the back side is blocked). These two pairs of the external-lock openings 11c and 11d and the two pairs of the external-lock clicks 12c and 12d are positioned on the faces (both the left and right sides on the front and back sides described above in FIG. 1) on both sides sandwiching accommodation space S illustrated in FIG. 1 in the arrangement directions (X directions) of the first and second lead wires 5 and 6. Insertion of the external-lock clicks 12c and 12d into the external-lock openings 11c and 11d makes these members function as at least an example of a pair of first lock mechanisms that lock the first-insulation-case member 11 and the second-insulation-case member 12 together. The first-insulation-case member 11 and the second-insulation-case member 12 are thus locked together, and thereby the first-insulation-case member 11 and the second-insulation-case member 12 are fit into each other. The first lock mechanism is not limited to a configuration having a click such as the external-lock clicks 12c and 12d, but may employ a different configuration such as for example one using a member for achieving interference-fit. Also, it is better to respectively arrange the external-lock openings 11c and 11d and the external-lock clicks 12c and 12d around the four corners of the insulation case 10 in a planar view.

The pair of the near-side convex portions 11e of the first-insulation-case member 11 project toward the center side of the insulation case 10 in the arrangement directions of the first and second lead wires 5 and 6 (X directions), and are arranged at opposed positions in this arrangement directions (X directions) (in FIG. 1 and FIG. 3, only the back side is illustrated and the front side is blocked). Also, the pair of the near-side grooves 12e and 12e of the second-insulation-case member 12 are open toward the outside in the arrangement directions of the first and second lead wires 5 and 6 (X directions), and are arranged at opposed positions in this arrangement directions (X directions). Insertion of the pair of the near-side convex portions 11e into the pair of the near-side grooves 12e locks or positions the first-insulation-case member 11 and the second-insulation-case member 12.

One far-side groove 12f of the second-insulation-case member 12 is open over the upper side (one of the Z directions) and the front and back sides (both of the X directions) in FIG. 1 and FIG. 3, accepts the insertion of a far-side convex portion (not illustrated) formed inside the first-insulation-case member 11, and thereby locks or positions the first-insulation-case member 11 and the second-insulation-case member 12.

The temperature switch 1 according to the first embodiment described above includes the temperature detection unit 4 configured to detect a temperature so as to move the movable contact 2 to a position that is in contact with the fixed contact 3 and to a position that is separated from the fixed contact 3, the first lead wire 5 that is connected to the fixed contact 3 and that includes the covering member 5a, the second lead wire 6 that is connected to the movable contact 2 and that includes the covering member 6a, the first-insulation-case member 11, and the second-insulation-case member 12. The first-insulation-case member 11 includes the first-lead-wire concave portion 11a and the second-lead-wire concave portion 11b while the second-insulation-case member 12 includes the first-lead-wire concave portion 12a and the second-lead-wire concave portion 12b, and the first-insulation-case member 11 and the second-insulation-case member 12 are fit into each other so as to form accommodation space S that accommodates the temperature detection unit 4, the movable contact 2, and the fixed contact 3, where the first-lead-wire concave portions 11a and 12a accept the insertion of the covering member 5a of the first lead wire 5 and the second-lead-wire concave portions 11b and 12b accept the insertion of the covering member 6a of the second lead wire 6.

Thus, fitting the first-insulation-case member 11 and the second-insulation-case member 12 enables the first and second lead wires 5 and 6 to be held with an operation easier than in the conventional configuration that uses a filling material. Further, the first-insulation-case member 11 and the second-insulation-case member 12 are not so likely to peel from the covering members 5a and 6a of the first and second lead wires 5 and 6 as in the configuration using a filling material, eliminating the necessity to limit, in order to prevent the peeling, the way of the provision such as for example limiting the range within which the lead wires 5 and 6 can bend.

The first embodiment thus makes it possible, through a simple assembly operation, to prevent damage to the covering members 5a and 6a of the first and second lead wires 5 and 6 and to surely hold the first and second lead wires 5 and 6.

### Second Embodiment

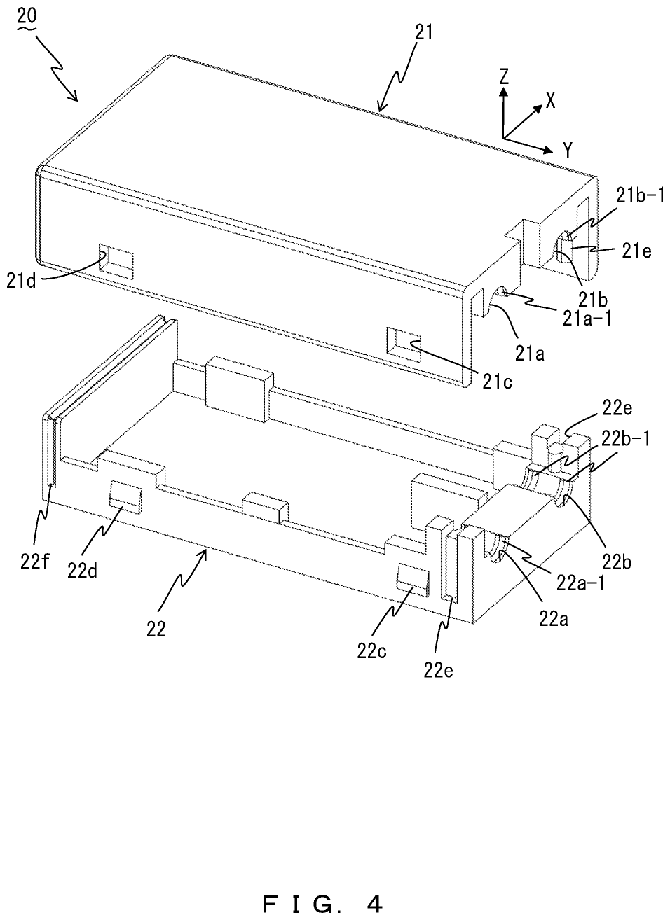

FIG. 4 is an exploded perspective view illustrating a temperature-switch insulation case 20 according to the second embodiment. The insulation case 20 according to the second embodiment may be similar to the insulation case 10 according to the first embodiment described above except that first-lead-wire concave portions 21a and 22a and second-lead-wire concave portions 21b and 22b of a first-insulation-case member 21 and a second-insulation-case member 22 include a plurality of ribs 21a-1, 22a-1, 21b-1, and 22b-1 formed on them. Accordingly, constituents in FIG. 4 that are similar to those denoted by the numbers between 10 and 19 in FIG. 3 are denoted by the numbers between 20 and 29 in such a manner that the constituents similar in FIG. 3 and FIG. 4 have the same ones place digits, and their explanations will be omitted.

On each of the first-lead-wire concave portions 21a and 22a and the second-lead-wire concave portions 21b and 22b, a plurality of ribs 21a-1, 22a-1, 21b-1, and 22b-1 are formed that project at positions apart in the axial directions (Y directions) of the first and second lead wires 5 and 6. While two ribs exist for each of the numerals (21a-1, 22a-1, 21b-1, and 22b-1) in the example illustrated in FIG. 4, the two ribs (the ribs 22b-1) are illustrated only for the second-lead-wire concave portion 22b of the second-insulation-case member 22, and only one each of the ribs 21a-1, 21b-1, and 21b-1 is illustrated for the first-lead-wire concave portion 21a the second-lead-wire concave portion 21b of the first-insulation-case member 21 and the first-lead-wire concave portion 22a of the second-insulation-case member 22 because the other each of them is behind other members.

The plurality of ribs 21a-1 of the first-lead-wire concave portion 21a of the first-insulation-case member 21 and the plurality of ribs 22a-1 of the first-lead-wire concave portion 22a of the second-insulation-case member 22 come into contact with each other so as to tighten the covering member 5a of the first lead wire 5 illustrated in FIG. 1 and FIG. 2 all along the circumference of the covering member 5a.

However, while it is desirable that the plurality of the ribs 21b-1 of the second-lead-wire concave portion 21b of the first-insulation-case member 21 and the plurality of ribs 22b-1 of the second-lead-wire concave portion 22b of the second-insulation-case member 22 come into contact with each other so as to tighten the covering member 6a of the second lead wire 6 illustrated in FIG. 1 and FIG. 2 all along the circumference of the covering member 6a, a configuration is also possible in which the ribs 21a-1 and 22a-1 of the first-lead-wire concave portions 21a and 22a do not come into contact with each other, the ribs 21b-1 and 22b-1 of the second-lead-wire concave portions 21b and 22b do not come into contact with each other, and the covering members 5a and 6a of the first and second lead wires 5 and 6 are not tightened all along the circumference of them at the same locations. A configuration is also possible in which each of the first-lead-wire concave portions 21a and 22a and the second-lead-wire concave portions 21b and 22b includes one rib instead of the plurality of ribs 21a-1, 22a-1, 21b-1, and 22b-1 that are apart in the axial directions (Y directions).

The second embodiment can achieve an effect that the first and second lead wires 5 and 6 can be held more surely, in addition to the effects achieved by the above first embodiment.

### Third Embodiment

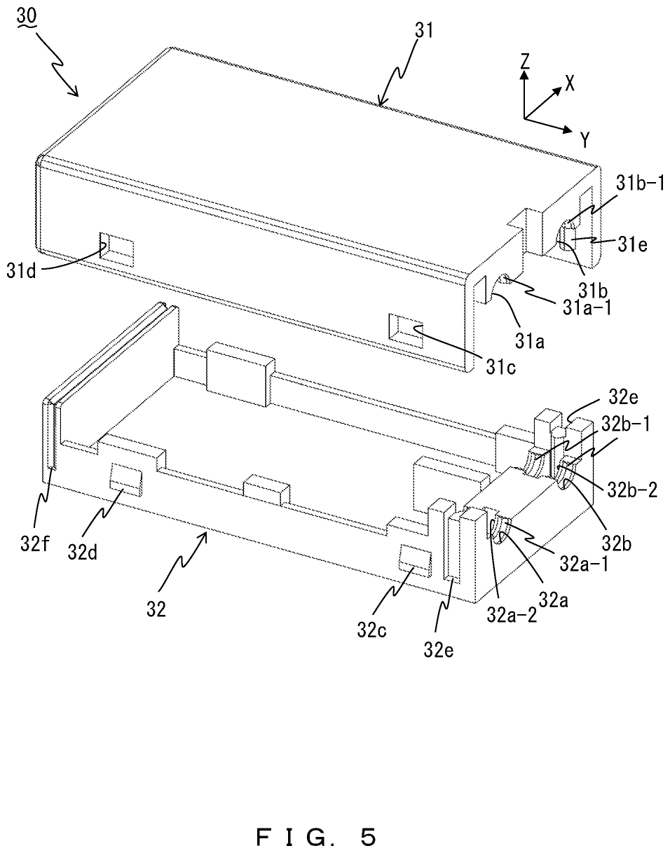

FIG. 5 is an exploded perspective view illustrating a temperature-switch insulation case 30 according to the third embodiment. The insulation case 30 according to the third embodiment may be similar to the insulation cases 10 and 20 according to the first and second embodiments above except that first-lead-wire concave portions 31a and 32a and second-lead-wire concave portions 31b and 32b of at least one (or both desirably) of a first-insulation-case member 31 and a second-insulation-case member 32 include indentations 32a-2 and 32b-2 at positions between the plurality of ribs (the indentation of the first-insulation-case member 31 is not illustrated because it is behind another member). Accordingly, constituents in FIG. 5 that are similar to those denoted by the numbers between 20 and 29 in FIG. 4 are denoted by the numbers between 30 and 39 in such a manner that the constituents similar in FIG. 4 and FIG. 5 have the same ones place digits, and their explanations will be omitted.

It is desirable that the indentations 32a-2 and 32b-2 be provided for example all along the circumference of the covering members 5a and 6a of the first and second lead wires 5 and 6 illustrated in FIG. 1 and FIG. 2. According to the third embodiment, the indentations 32a-2 and 32b-2 positioned between a plurality of ribs 31a-1, 32a-1, 31b-1, and 32b-1 accommodate the covering members 5a and 6a of the first and second lead wires 5 and 6 that have been elastically deformed by being tightened by the plurality of ribs 31a-1,32a-1, 31b-1,and 32b-1, and thereby spaces are ensured to which the covering members 5a and 6a of the first and second lead wires 5 and 6 that have been elastically deformed are relieved. This can achieve an effect that the first and second lead wires 5 and 6 can be held further surely, in addition to the effects of the first and second embodiments.

### Fourth Embodiment

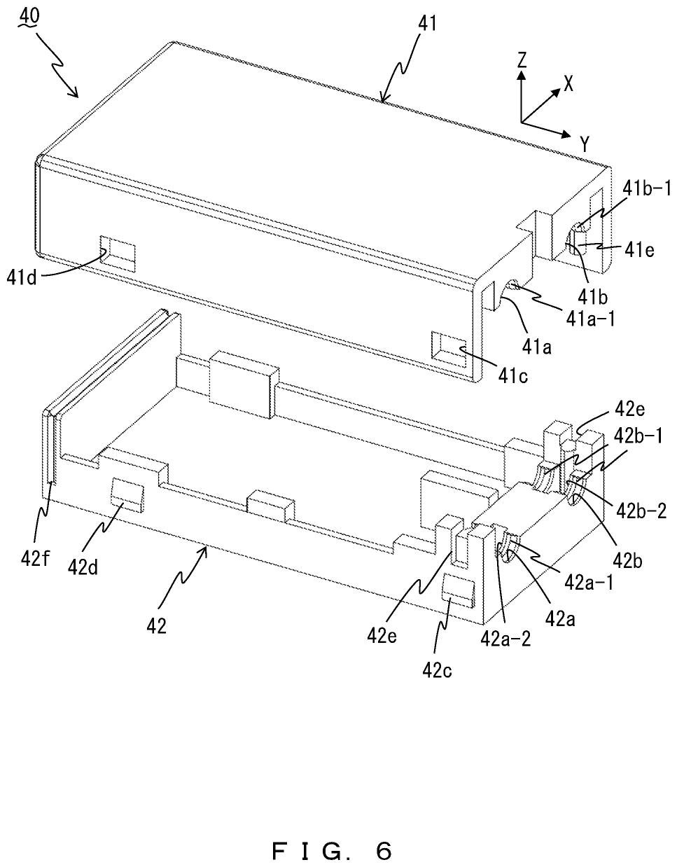

FIG. 6 is an exploded perspective view illustrating a temperature-switch insulation case 40 according to the fourth embodiment. In the insulation case 40 according to the fourth embodiment, a pair of external-lock openings 41c, which is one of two pairs of external-lock openings 41c and 41d, and a pair of external-lock clicks 42c, which is one of two pairs of external-lock clicks 42c and 42d of the second-insulation-case member 42, intersect a plane (X-Z plane) that contains the midpoints of the first-lead-wire concave portions 41a and 42a and the second-lead-wire concave portions 41b and 42b in the axial directions (Y directions) and that is orthogonal to the axial directions (Y directions), the first-lead-wire concave portions 41a and 42a and the second-lead-wire concave portions 41b and 42b being parallel to the axial directions (Y directions) of the first and second lead wires 5 and 6 illustrated in FIG. 1 and FIG. 2. Except this, the insulation case 40 according to the fourth embodiment may be similar to the insulation cases 10, 20, and 30 according to the first through third embodiments. Accordingly, constituents in FIG. 6 that are similar to those denoted by the numbers between 30 and 39 in FIG. 5 are denoted by the numbers between 40 and 49 in such a manner that the constituents similar in FIG. 5 and FIG. 6 have the same ones place digits, and their explanations will be omitted.

A near-side convex portion 41e of the first-insulation-case member 41 and a near-side groove 42e of the second-insulation-case member 42 are shorter, in the downward direction (Z direction) than a near-side convex portion 31e and a near-side groove 32e illustrated in FIG. 5 (third embodiment) so that they do not cause interference with a pair of external-lock openings 41c and a pair of external-lock clicks 42c.

The fourth embodiment can achieve, in addition to the effects of the first through third embodiments, an effect that the balance (balance of stresses) of repelling forces generated by the compression of the covering members 5a and 6a of the first and second lead wires 5 and 6 can be adjusted by locking the first-insulation-case member 41 and the second-insulation-case member 42 near the portions in which these repelling forces are generated.

### Fifth Embodiment

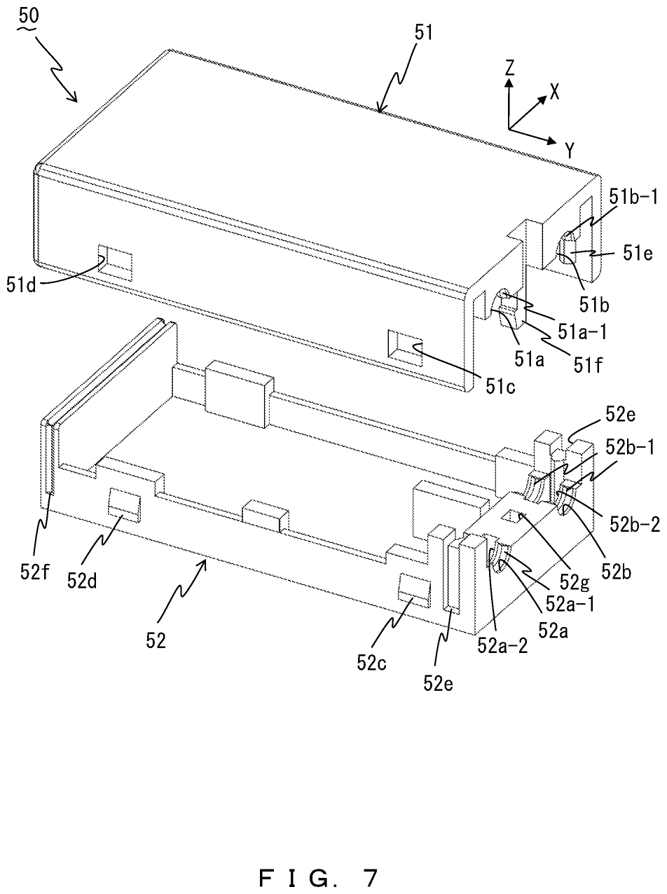

FIG. 7 is an exploded perspective view illustrating a temperature-switch insulation case 50 according to the fifth embodiment. The insulation case 50 according to the fifth embodiment may be similar to the insulation cases 10, 20, 30, and 40 according to the first through fourth embodiments except that a first-insulation-case member 51 includes a second lock mechanism between a first-lead-wire concave portion 51a and a second-lead-wire concave portion 51b and that a second-insulation-case member 52 includes a second lock mechanism between a first-lead-wire concave portion 52a and a second-lead-wire concave portion 52b. Accordingly, constituents in FIG. 7 that are similar to those denoted by the numbers between 30 and 39 in FIG. 5 are denoted by the numbers between 50 and 59 in such a manner that the constituents similar in FIG. 5 and FIG. 7 have the same ones place digits, and their explanations will be omitted.

Examples of the second lock mechanisms may include an internal-lock click 51f for the first-insulation-case member 51 and an internal-lock opening 52g for the second-insulation-case member 52. Note that the second lock mechanism is not limited to a configuration having a click such as the internal-lock click 51f, but may employ a different configuration such as for example one using a member for achieving interference-fit. It is desirable that the internal-lock click 51f and the internal-lock opening 52g be in the middle in the arrangement directions (X directions) of the first and second lead wires 5 and 6 in the insulation case 50. The internal-lock click 51f projects downward (Z direction) from the first-insulation-case member 51 and has its tip portion projecting in one of the arrangement directions of the first and second lead wires 5 and 6 (X directions) illustrated in FIG. 1 and FIG. 2, similarly to external-lock clicks 52c and 52d constituting the first lock mechanism. In other words, the internal-lock click 51f achieves locking in a direction parallel to the locking directions of the external-lock clicks 52c and 52d. Note that the internal-lock opening 52g not only extends vertically, but also has a space to accommodate the projecting tip portion of the internal-lock click 51f. Also, the internal-lock opening 52g is provided in such a manner that the internal-lock opening 52g for example pierces the second-insulation-case member 52 vertically (Z directions) in order to facilitate molding.

The fifth embodiment enables the internal-lock click 51f and the internal-lock opening 52g, which are examples of second lock mechanisms, to more surely suppress repelling forces near the portions in which these repelling forces are generated, the repelling forces being generated by the compression of the covering members 5a and 6a of the first and second lead wires 5 and 6. This can achieve an effect that the first and second lead wires 5 and 6 can be held further surely, in addition to the effects of the first through fourth embodiments.

### Sixth Embodiment

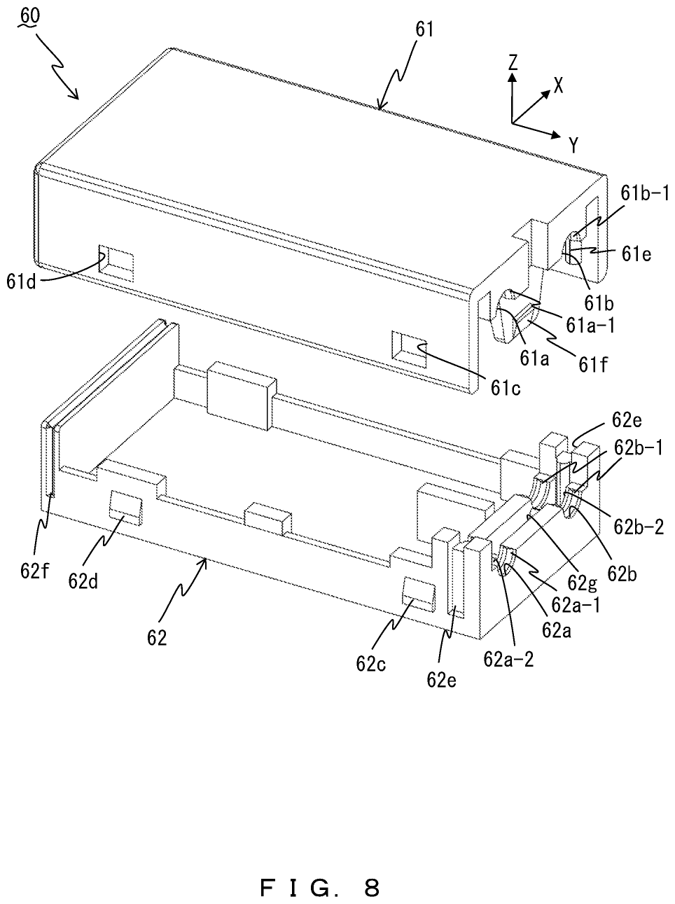

FIG. 8 is an exploded perspective view illustrating a temperature-switch insulation case 60 according to the sixth embodiment. The insulation case 60 according to the sixth embodiment has an internal-lock click 61f and an internal-lock opening 62g that achieve locking in the directions orthogonal (Y directions), instead of parallel, to the locking directions (X directions) of external-lock openings 61c and 61d and external-lock clicks 62c and 62d as examples of first lock mechanisms, the internal-lock click 61f and the internal-lock opening 62g being examples of second lock mechanisms. In other words, the internal-lock click 61f projects downward (Z direction) from the first-insulation-case member 61 and has its tip portion in one of the axial directions (Y directions) of the first and second lead wires 5 and 6. Except this, the insulation case 60 according to the sixth embodiment may be similar to the insulation cases 10, 20, 30, 40, and 50 according to the first through fifth embodiments. Accordingly, constituents in FIG. 8 that are similar to those denoted by the numbers between 50 and 59 in FIG. 7 are denoted by the numbers between 60 and 69 in such a manner that the constituents similar in FIG. 7 and FIG. 8 have the same ones place digits, and their explanations will be omitted.

According to the sixth embodiment, the internal-lock click 61f and the internal-lock opening 62g cooperate with the external-lock openings 61c and 61d and the external-lock clicks 62c and 62d, have the locking directions orthogonal to each other, and thereby can further surely suppress repelling forces caused by the compression of the covering members 5a and 6a of the first and second lead wires 5 and 6 and also can ensure the symmetry of the insulation case 60 in the arrangement directions (X directions) of the first and second lead wires 5 and 6. This can achieve an effect that the first and second lead wires 5 and 6 can be held further surely, in addition to the effects of the first through fifth embodiments.

While the first through sixth embodiments of the present invention have been explained above, the present invention is included in the scope of the inventions described in the claims and their equivalents. Below, the inventions described in the original claims of the present application as filed are added as appendixes.

### Appendixes

Appendix 1. A temperature switch comprising:

a temperature detection unit configured to detect a temperature so as to move a movable contact to a position that is in contact with a fixed contact and to a position that is separated from the fixed contact;

a first lead wire that is connected to the fixed contact and that includes a covering member;

a second lead wire that is connected to the movable contact and that includes a covering member; and

a first-insulation-case member and a second-insulation-case member each of which includes a first-lead-wire concave portion and a second-lead-wire concave portion, and which are fit into each other so as to form an accommodation space that accommodates the temperature detection unit, the movable contact, and the fixed contact, where the first-lead-wire concave portion accepts insertion of the covering member of the first lead wire and the second-lead-wire concave portion accepts insertion of the covering member of the second lead wire.

Appendix 2. The temperature switch according to appendix 1, wherein

a plurality of ribs that project at positions apart in axial directions of the first lead wire are formed on the first-lead-wire concave portions,

a plurality of ribs that project at positions apart in axial directions of the second lead wire are formed on the second-lead-wire concave portions,

the plurality of ribs of the first-lead-wire concave portion of the first-insulation-case member and the plurality of ribs of the first-lead-wire concave portion of the second-insulation-case member come into contact with each other so as to tighten the covering member of the first lead wire all along circumference of the covering member of the first lead wire, and

the plurality of ribs of the second-lead-wire concave portion of the first-insulation-case member and the plurality of ribs of the second-lead-wire concave portion of the second-insulation-case member come into contact with each other so as to tighten the covering member of the second lead wire all along circumference of the covering member of the second lead wire.

Appendix 3. The temperature switch according to appendix 2, wherein

the first-lead-wire concave portion and the second-lead-wire concave portion of at least one of the first-insulation-case member and the second-insulation-case member include an indentation between the plurality of ribs.

Appendix 4. The temperature switch according to appendix 1, wherein

the first-lead-wire concave portions and the second-lead-wire concave portions extend in axial directions of the first lead wire and the second lead wire parallel to each other, and are arranged in opposed directions of the first-lead-wire concave portion and the second-lead-wire concave portion of the first-insulation-case member and the first-lead-wire concave portion and the second-lead-wire concave portion of the second-insulation-case member and in arrangement directions orthogonal to the axial directions,

each of the first-insulation-case member and the second-insulation-case member further includes a pair of first lock mechanisms that are positioned on faces on both sides sandwiching the accommodation space in the arrangement directions and that are for locking the first-insulation-case member and the second-insulation-case member,

the first-lead-wire concave portion and the second-lead-wire concave portion are parallel to the axial direction of the first lead wire and the second lead wire, and

the pair of the first lock mechanisms intersect a plane that contains midpoints of the first-lead-wire concave portion and the second-lead-wire concave portion in the axial directions and that is orthogonal to the axial directions.

Appendix 5. The temperature switch according to appendix 1, wherein

each of the first-insulation-case member and the second-insulation-case member further includes a second lock mechanism that is positioned between the first-lead-wire concave portion and the second-lead-wire concave portion and that is for locking the first-insulation-case member and the second-insulation-case member.

Appendix 6. The temperature switch according to appendix 5, wherein

the first-lead-wire concave portions and the second-lead-wire concave portions extend in axial directions of the first lead wire and the second lead wire parallel to each other, and are arranged in opposed directions of the first-lead-wire concave portion and the second-lead-wire concave portion of the first-insulation-case member and the first-lead-wire concave portion and the second-lead-wire concave portion of the second-insulation-case member and in arrangement directions orthogonal to the axial directions,

each of the first-insulation-case member and the second-insulation-case member further includes a pair of first lock mechanisms that are positioned on faces on both sides sandwiching the accommodation space in the arrangement directions and that are for locking the first-insulation-case member and the second-insulation-case member, and

the second lock mechanisms lock the first-insulation-case member and the second-insulation-case member in directions that are orthogonal to directions in which the pair of the first lock mechanisms lock the first-insulation-case member and the second-insulation-case member.

Appendix 7. A temperature-switch insulation case arranged in a temperature switch that includes a temperature detection unit configured to detect a temperature so as to move a movable contact to a position that is in contact with a fixed contact and to a position that is separated from the fixed contact, the temperature-switch insulation case comprising:

a first-insulation-case member and a second-insulation-case member each of which includes a first-lead-wire concave portion and a second-lead-wire concave portion, and which are fit into each other, where the first-lead-wire concave portion accepts insertion of a covering member of a first lead wire that is connected to the fixed contact and that includes the covering member and the second-lead-wire concave portion accepts insertion of a covering member of a second lead wire that is connected to the movable contact and that includes the covering member.

### Symbols

| | |
|---|---|
| 1 | TEMPERATURE SWITCH |
| 2 | MOVABLE CONTACT |
| 3 | FIXED CONTACT |
| 4 | TEMPERATURE DETECTION UNIT |
| 4a | BIMETAL |
| 4b | MOVABLE PLATE |
| 5 | FIRST LEAD WIRE |
| 5a | COVERING MEMBER |
| 6 | SECOND LEAD WIRE |
| 6a | COVERING MEMBER |
| 10, 20, 30, 40, 50, 60 | INSULATION CASE |
| 11, 21, 31, 41, 51, 61 | FIRST-INSULATION-CASE MEMBER |
| 12, 22, 32, 42, 52, 62 | SECOND-INSULATION-CASE MEMBER |
| 11a, 12a, 21a, 22a, 31a, 32a, 41a, 42a, 51a, 52a, 61a, 62a | FIRST-LEAD-WIRE |
| | CONCAVE PORTION |
| 11b, 12b, 21b, 22b, 31b, 32b, 41b, 42b, 51b, 52b, 61b, 62b | SECOND-LEAD-WIRE |
| | CONCAVE PORTION |
| 11a-1, 11b-1, 12a-1, 12b-1 | CHAMFERED PORTION |
| 21a-1, 21b-1, 22a-1, 22b-1, 31a-1, 31b-1, 32a-1, 32b-1, | RIB |
| 41a-1, 41b-1, 42a-1, 42b-1, 51a-1, 51b-1, 52a-1, 52b-1, | |
| 61a-1, 61b-1, 62a-1, 62b-1 | |
| 32a-2, 32b-2, 42a-2, 42b-2, 52a-2, 52b-2, 62a-2, 62b-2 | INDENTATION |
| 11c, 11d, 21c, 21d, 31c, 31d, 41c, 41d, 51c, 51d, 61c, 61d | EXTERNAL-LOCK |
| | OPENING |
| 12c, 12d, 22c, 22d, 32c, 32d, 42c, 42d, 52c, 52d, 62c, 62d | EXTERNAL-LOCK |
| | CLICK |
| 11e, 21e, 31e, 41e, 51e, 61e | NEAR-SIDE CONVEX PORTION |
| 12e, 22e, 32e, 42e, 52e, 62e | NEAR-SIDE GROOVE |
| 12f, 22f, 32f, 42f, 52f, 62f | FAR-SIDE GROOVE |
| 51f, 61f | INTERNAL-LOCK CLICK |
| 52g, 62g | INTERNAL-LOCK OPENING |
| S | ACCOMMODATION SPACE |
| X | ARRANGEMENT DIRECTIONS OF FIRST LEAD WIRE AND SECOND |
| | LEAD WIRE |
| Y | AXIAL DIRECTIONS OF FIRST LEAD WIRE AND SECOND LEAD WIRE |
| Z | OPPOSED DIRECTIONS OF FIRST-LEAD-WIRE CONCAVE PORTION |
| | AND SECOND-LEAD-WIRE CONCAVE PORTION |

1. A temperature switch comprising:
a temperature detection unit configured to detect a temperature so as to move a movable contact to a position that is in contact with a fixed contact and to a position that is separated from the fixed contact;
a first lead wire that is connected to the fixed contact and that includes a covering member;
a second lead wire that is connected to the movable contact and that includes a covering member; and
a first-insulation-case member and a second-insulation-case member each of which includes a first-lead-wire concave portion and a second-lead-wire concave portion, and which are fit into each other so as to form an accommodation space that accommodates the temperature detection unit, the movable contact, and the fixed contact, where the first-lead-wire concave portion accepts insertion of the covering member of the first lead wire and the second-lead-wire concave portion accepts insertion of the covering member of the second lead wire, wherein
the first-lead-wire concave portions and the second-lead-wire concave portions extend in axial directions of the first lead wire and the second lead wire parallel to each other, and are arranged in opposed directions of the first-lead-wire concave portion and the second-lead-wire concave portion of the first-insulation-case member and the first-lead-wire concave portion and the second-lead-wire concave portion of the second-insulation-case member and in arrangement directions orthogonal to the axial directions,
each of the first-insulation-case member and the second-insulation-case member further includes at least one pair of first lock mechanisms that are positioned on faces on both sides sandwiching the accommodation space in the arrangement directions and that are for locking the first-insulation-case member and the second-insulation-case member, and
the pair of the first lock mechanisms intersect a plane that contains midpoints of the first-lead-wire concave portion and the second-lead-wire concave portion in the axial directions and that is orthogonal to the axial directions.

2. A temperature switch comprising:
a temperature detection unit configured to detect a temperature so as to move a movable contact to a position that is in contact with a fixed contact and to a position that is separated from the fixed contact;
a first lead wire that is connected to the fixed contact and that includes a covering member;
a second lead wire that is connected to the movable contact and that includes a covering member; and
a first-insulation-case member and a second-insulation-case member each of which includes a first-lead-wire concave portion and a second-lead-wire concave portion, and which are fit into each other so as to form an accommodation space that accommodates the temperature detection unit, the movable contact, and the fixed contact, where the first-lead-wire concave portion accepts insertion of the covering member of the first lead wire and the second-lead-wire concave portion accepts insertion of the covering member of the second lead wire, wherein
each of the first-insulation-case member and the second-insulation-case member further includes a second lock mechanism that is positioned between the first-lead-wire concave portion and the second-lead-wire concave portion and that is for locking the first-insulation-case member and the second-insulation-case member.

3. The temperature switch according to claim 1, wherein
a plurality of ribs that project at positions apart in axial directions of the first lead wire are formed on the first-lead-wire concave portions,
a plurality of ribs that project at positions apart in axial directions of the second lead wire are formed on the second-lead-wire concave portions,
the plurality of ribs of the first-lead-wire concave portion of the first-insulation-case member and the plurality of ribs of the first-lead-wire concave portion of the second-insulation-case member come into contact with each other so as to tighten the covering member of the first lead wire all along circumference of the covering member of the first lead wire, and
the plurality of ribs of the second-lead-wire concave portion of the first-insulation-case member and the plurality of ribs of the second-lead-wire concave portion of the second-insulation-case member come into contact with each other so as to tighten the covering member of the second lead wire all along circumference of the covering member of the second lead wire.

4. The temperature switch according to claim 3, wherein
the first-lead-wire concave portion and the second-lead-wire concave portion of at least one of the first-insulation-case member and the second-insulation-case member include an indentation between the plurality of ribs.

5. (canceled)

6. The temperature switch according to claim 2, wherein
the first-lead-wire concave portions and the second-lead-wire concave portions extend in axial directions of the first lead wire and the second lead wire parallel to each other, and are arranged in opposed directions of the first-lead-wire concave portion and the second-lead-wire concave portion of the first-insulation-case member and the first-lead-wire concave portion and the second-lead-wire concave portion of the second-insulation-case member and in arrangement directions orthogonal to the axial directions,
each of the first-insulation-case member and the second-insulation-case member further includes at least one pair of first lock mechanisms that are positioned on faces on both sides sandwiching the accommodation space in the arrangement directions and that are for locking the first-insulation-case member and the second-insulation-case member, and
the second lock mechanisms lock the first-insulation-case member and the second-insulation-case member in directions that are orthogonal to directions in which the pair of the first lock mechanisms lock the first-insulation-case member and the second-insulation-case member.

7. A temperature-switch insulation case arranged in a temperature switch that includes a temperature detection unit configured to detect a temperature so as to move a movable contact to a position that is in contact with a fixed contact and to a position that is separated from the fixed contact, the temperature-switch insulation case comprising:
a first-insulation-case member and a second-insulation-case member each of which includes a first-lead-wire concave portion and a second-lead-wire concave portion, and which are fit into each other so as to form an accommodation space that accommodates the temperature detection unit, the movable contact, and the fixed contact, where the first-lead-wire concave portion accepts insertion of a covering member of a first lead wire that is connected to the fixed contact and that includes the covering member and the second-lead-wire concave portion accepts insertion of a covering member of a second lead wire that is connected to the movable contact and that includes the covering member, wherein
the first-lead-wire concave portions and the second-lead-wire concave portions extend in axial directions of the first lead wire and the second lead wire parallel to each other, and are arranged in opposed directions of the first-lead-wire concave portion and the second-lead-wire concave portion of the first-insulation-case member and the first-lead-wire concave portion and the second-lead-wire concave portion of the second-insulation-case member and in arrangement directions orthogonal to the axial directions,
each of the first-insulation-case member and the second-insulation-case member further includes at least one pair of first lock mechanisms that are positioned on faces on both sides sandwiching the accommodation space in the arrangement directions and that are for locking the first-insulation-case member and the second-insulation-case member, and
the pair of the first lock mechanisms intersect a plane that contains midpoints of the first-lead-wire concave portion and the second-lead-wire concave portion in the axial directions and that is orthogonal to the axial directions.

8. The temperature-switch insulation case according to claim 7, wherein
each of the first-insulation-case member and the second-insulation-case member further includes a second lock mechanism that is positioned between the first-lead-wire concave portion and the second-lead-wire concave portion and that is for locking the first-insulation-case member and the second-insulation-case member.

9. The temperature switch according to claim 2, wherein
a plurality of ribs that project at positions apart in axial directions of the first lead wire are formed on the first-lead-wire concave portions,
a plurality of ribs that project at positions apart in axial directions of the second lead wire are formed on the second-lead-wire concave portions,
the plurality of ribs of the first-lead-wire concave portion of the first-insulation-case member and the plurality of ribs of the first-lead-wire concave portion of the second-insulation-case member come into contact with each other so as to tighten the covering member of the first lead wire all along circumference of the covering member of the first lead wire, and
the plurality of ribs of the second-lead-wire concave portion of the first-insulation-case member and the plurality of ribs of the second-lead-wire concave portion of the second-insulation-case member come into contact with each other so as to tighten the covering member of the second lead wire all along circumference of the covering member of the second lead wire.
